(19) United States
(12) Patent Application Publication
(10) Pub. No.: US 2016/0060022 A1
(43) Pub. Date: Mar. 3, 2016

(54) APPARATUS FOR PROVIDING COCKTAIL MIX

(71) Applicant: John Frank Stagl, Bradenton, FL (US)

(72) Inventor: John Frank Stagl, Bradenton, FL (US)

(21) Appl. No.: 14/470,531

(22) Filed: Aug. 27, 2014

(51) Int. Cl. B65D 85/72; B65D 25/20; G01F 19/00

(52) U.S. Cl. CPC B65D 85/72; G01F 19/00; B65D 25/205

(57) ABSTRACT

The present disclosure provides an apparatus for dispensing a cocktail mixture. The apparatus includes a container, a label and a measuring device. The container is configured to store the cocktail mixture. The cocktail mixture includes a plurality of ingredients in a pre-determined amount, and the plurality of ingredients includes one or more diluters. In addition, the cocktail mixture is configured for one time use. Further, the cocktail mixture is configured to prepare two servings. Furthermore, the cocktail mixture is storable in a non-refrigerating mode. The label is embossed on the container. In addition, the label displays the plurality of ingredients present in the cocktail mixture. The measuring device is embossed on at least one of the label and the container. The measuring device indicates amount of alcohol to be mixed with the cocktail mixture.

### TECHNICAL FIELD

The present invention relates to an apparatus for dispensing cocktail mix and, in particular, relates to cocktail dispensing apparatus providing appropriate quantities of ingredients for a perfect cocktail mix.

### BACKGROUND

Cocktails are any generic alcoholic mixed drinks or beverages containing two or more ingredients, at least one of them is alcohol. The cocktails can be prepared in various manners by varying concentration of different ingredients. Generally, the ingredients of the cocktails include mixers, liquors, garnishes and the like. Examples of the mixers include but may not be limited to soda water, cola, cranberry juice and mint leaves. In addition, examples of the liquors include but may not be limited to whiskey, gin, vodka, white rum, tequila, Cointreau, brandy and champagne. Further, examples of the garnishes include but may not be limited to maraschino cherries, lemons and limes, olives, fruit slices and cocktail onions. The cocktails are prepared using different combination of the mixers, liquors and the garnishes. Examples of the cocktails include but may not be limited to martini, margaritas, daiquiris and bloody Mary. Generally, these ingredients are mixed at the time of serving of the cocktails to guests or any individual. This is due to the fact that the cocktails get contaminated or spoiled if left without taking appropriate measures. In addition, the cocktails are distributed and sold in quantities with adequate refrigeration and preservatives to maintain freshness and prevent spoiling. Further, improperly stored cocktails may pose a health hazard.

In practice, few hosts or bartenders manually mix the ingredients every time a new guest demands a cocktail drink. The manual preparation of the cocktail drinks involves a number of problems. For example, at a large cocktail party, a reception, a number of bar locations and the like, a large number of bartenders or hosts are required to prepare the cocktail drinks for a large number of guests. Thus, it leads to time wastage and inappropriate/poor cocktail drinks. Generally, the bartenders use mixing glasses, shakers and the like to prepare the cocktail drinks. The mixing glasses, shakers and the like enable measuring out of appropriate quantities of the ingredients for preparing the perfect cocktail drinks.

However, to solve these problems, various companies have concocted and marketed dry powder mixes, liquid pre-mixes, and pre-frozen products as pre-mixed portions to prepare the cocktails. While these mixes avoid the inconvenience of separately buying, storing and measuring the ingredients, the problems associated with the chemical preservatives, freezing point depressants and other components that might affect flavour of the cocktail drink remain. Further, the pre-mix must be measured out to make the cocktail drinks in required quantity. Furthermore, without even addressing the important issue of taste or flavour, the pre-mixes suffers from the fact that these must be stored frozen, sold frozen, and maintained in a frozen state until used.

There are few patents/patent applications/non patent literatures which provide methods and apparatuses for providing the pre-mixes of the cocktails. For example, in an EP0726225 B1, a beverage dispensing system with bottle identification mechanism is provided. The stated system enables automatic dispensing of a measured or predefined quantity of beverage from a bottle or a container. However, the prior art does not teach regarding a single use container with a built-in measuring device minimizing use of the chemical preservatives, freezing point depressants and like components that may pose a serious health hazard.

In another, U.S. Pat. No. 3,920,149 A, a beverage dispensing apparatus and method is provided. The apparatus and method dispenses a beverage or liquid from a container, wherein the container is provided with a normally closed valve removably mounted on fluid outlet. The apparatus and method for liquor dispensing system utilizes a number of bottles of different types and grades of alcoholic beverages. In this system, each valve has a valve member movable to an open position in response to a magnetic field to permit liquid to be dispensed from the corresponding bottle. A tubular valve actuator is provided to receive the valve and to generate a magnetic field to open the valve when the container is inverted. Circuitry coupled to the actuator assures that the valve will be open only for a predetermined period of time so that only a preselected volume of the liquor will be dispensed from the container. Each valve has coding means thereon to distinguish it from other valves and permit identification of the type and quality of liquor in the corresponding bottle and such coding means is sensed when the valve is received within or adjacent to the actuator. However, the prior art does not teach regarding the single use container with a built-in measuring device minimizing the use of the chemical preservatives, the freezing point depressants and the like components that may pose a serious health hazard.

In yet another U.S. Pat. No. 2,887,252 A, a measuring liquid dispenser/dispensing apparatus is provided. The dispensing apparatus is adapted to deliver a predetermined volume of a liquid. In addition, the dispensing apparatus includes a special jug or reservoir adapted for exclusive registration with a dispenser base. However, the prior art does not teach regarding the storage and preservation of the cocktail mixes by the dispensing apparatus.

In yet another U.S. Pat. No. 3,940,019 A, an automatic mixed drink dispensing apparatus is provided. The automatic mixed drink dispensing apparatus includes a housing including a secured liquor receiving zone which receives a plurality of liquor containers. The housing also receives syrup containers, a water container, and a carbon dioxide container. An ice chest is mounted in the upper portion of the housing and has a liquid chilling apparatus in the bottom thereof. A dispensing head is mounted on the housing and extends into a mixed drink preparation zone. Drains extend from a point in the mixed drink preparation zone beneath the dispensing head and from a point in the bottom of the ice chest to a drain pan slidably supported in the bottom of the housing. Liquor pumps function to withdraw liquor from the liquor containers and to discharge the liquor through the dispensing head. The syrup containers are pressurized with carbon dioxide from the carbon dioxide container, whereby syrup is caused to flow through the liquid chilling apparatus and through the dispensing head. A water pump withdraws water from the water container and directs the water through the liquid chilling apparatus and through the dispensing head. The water pump also directs water into a carbonating apparatus which supplies carbonated water. The flow of the various liquids through the dispensing head is regulated by solenoid-actuated valves which are in turn controlled by electronic circuitry. The electronic circuitry responds to actuation of push-buttons individual to particular mixed drinks to select the liquids necessary in formulating a desired mixed drink and to actuate the valves to effect discharge of the proper amount of each liquid through the dispensing head. However, the prior art does not teach regarding the single use container with a built-in measuring device minimizing the use of the chemical preservatives, the freezing point depressants and the like components that may pose a serious health hazard.

In yet another USD 212840, an ornamental design for a dispenser for cocktail mixes is provided. However, the prior art does not teach regarding the single use container with a built-in measuring device minimizing the use of the chemical preservatives, the freezing point depressants and the like components that may pose a serious health hazard.

In yet another U.S. Pat. No. 3,656,316, a method and apparatus for preparing and dispensing large quantities of frozen cream cocktails is provided. The method and apparatus enables preparing and dispensing of a stored quantity of pre-mixed cream cocktails. The apparatus includes a refrigerated remote mixing and storage chamber wherein custard-cream and liquor in pre-selected proportions are blended and stored at the remote freezing storage chamber. An agitator in the mixing chamber continuously mixes the ingredients which are conveyed by air pressure to a freezing chamber upon actuation of a dispensing valve. The cream-liquor mix is aerated by an air injector as the mix is conveyed to the freezing chamber. However, the prior art does not teach regarding the storage of the cocktail mixes for long times. In addition, the prior art does not teach regarding the single use container with a built-in measuring device minimizing the use of the chemical preservatives, the freezing point depressants and the like components that may pose a serious health hazard.

In view of aforementioned problems discussed above, there is a need for a method and an apparatus which overcomes the above stated problems. In addition, the method and the apparatus should provide the appropriate cocktail mix that simplifies measuring and mixing of the ingredients. Further, the method and apparatus should provide the fresh cocktail mix using a single use container with a built-in measuring device minimizing the use of chemical preservatives, the freezing point depressants and the like components that may pose a serious health hazard.

### SUMMARY OF THE INVENTION

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter.

The present disclosure provides an apparatus for dispensing a cocktail mixture. The apparatus includes a container, a label and a measuring device. The container is configured to store the cocktail mixture. The cocktail mixture includes a plurality of ingredients in a pre-determined amount, and the plurality of ingredients includes one or more diluters. The label is attached to the container. In addition, the label displays the plurality of ingredients present in the cocktail mixture. The container is the measuring device as the measurement indicator is embossed on at least one of the label and the container.

In an embodiment of the present disclosure, the cocktail mixture provided in the apparatus is configured for one time use.

In another embodiment of the present disclosure, a single use container is provided with a built-in measuring device configured to minimize use of the chemical preservatives, freezing point depressants and like components that may pose a serious health hazard.

In yet another embodiment of the present disclosure, the cocktail mixture provided in the apparatus is configured to prepare two servings.

In yet another embodiment of the present disclosure, the cocktail mixture is storable in a non-refrigerating mode.

In yet another embodiment of the present disclosure, the cocktail mixture is packaged in the container under sterile environment.

In yet another embodiment of the present disclosure, the measuring device indicates amount of alcohol to be mixed with the cocktail mixture.

Other aspects and example embodiments are provided in the drawings and the detailed description that follows.

### BRIEF DESCRIPTION OF THE FIGURES

For a more complete understanding of example embodiments of the present technology, reference is now made to the following descriptions taken in connection with the accompanying drawings in which:

FIG. 1 illustrates an exemplary environment for a bar serving cocktails, in accordance with an embodiment of the present disclosure;

FIG. 2 illustrates an exemplary environment for a cocktail party, in accordance with an embodiment of the present disclosure;

FIG. 3 illustrates an exemplary environment showing interaction between a vendor and a consumer, in accordance with an embodiment of the present disclosure;

FIG. 4 illustrates a cocktail mix apparatus holding a cocktail mixture, in accordance with an embodiment of the present disclosure; and

FIG. 5 illustrates the cocktail mix apparatus with a label, in accordance with an embodiment of the present disclosure.

### DETAILED DESCRIPTION

In the following description, for purposes of explanation, numerous specific details are set forth in order to provide a thorough understanding of the present technology. It will be apparent, however, to one skilled in the art that the present technology can be practiced without these specific details. In other instances, structures and devices are shown in block diagram form only in order to avoid obscuring the present technology.

Reference in this specification to “one embodiment” or “an embodiment” means that a particular feature, structure, or characteristic described in connection with the embodiment is included in at least one embodiment of the present technology. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Moreover, although the following description contains many specifics for the purposes of illustration, anyone skilled in the art will appreciate that many variations and/or alterations to said details are within the scope of the present technology. Similarly, although many of the features of the present technology are described in terms of each other, or in conjunction with each other, one skilled in the art will appreciate that many of these features can be provided independently of other features. Accordingly, this description of the present technology is set forth without any loss of generality to, and without imposing limitations upon, the present technology.

In beverage trades, many drinks are sold by manufacturers in concentrated or pre-mixed forms to retail outlets. The retail outlets dilute a predetermined quantity of a concentrate or a pre-mix with a proportionate part of plain water, soda water, or other similar mixers and then serve to customers, clients, guests and the like. It is of great importance that the proper proportion of the concentrate or the pre-mix in the diluted solution be maintained at all times as any appreciable variation would lead to customer dissatisfaction and thus reflect on the quality of the manufacturers' product. Accordingly, it has been found desirable for the manufacturers to provide to each of his vendors a suitable cocktail dispenser that at each use will deliver the desired predetermined volume of the concentrate or the pre-mix into standard size glasses.

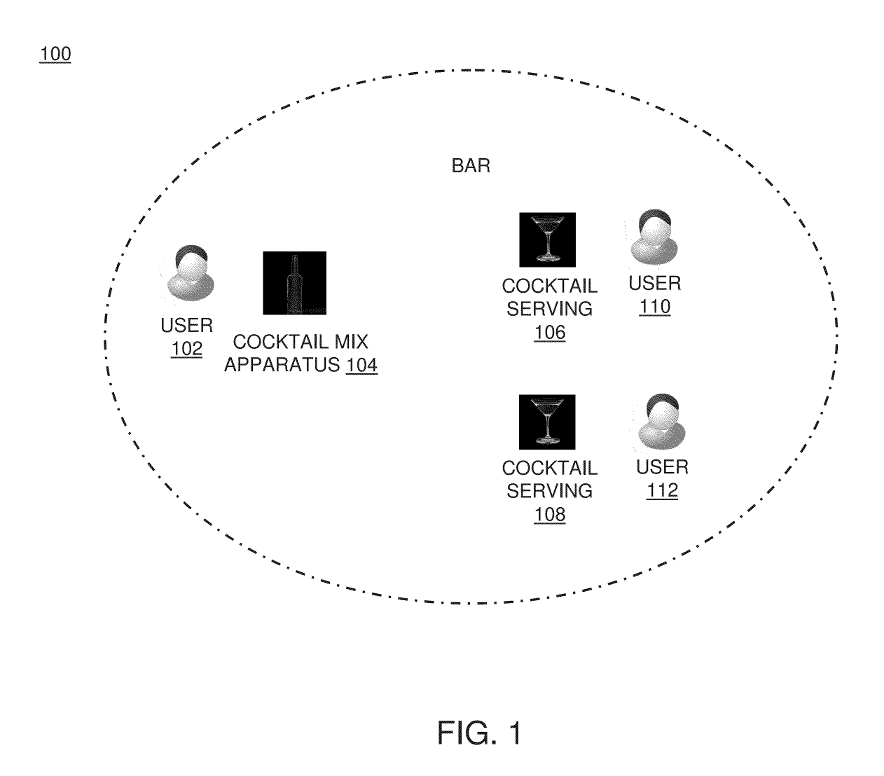

FIG. 1 illustrates an exemplary environment 100 for a bar serving cocktails, in accordance with an embodiment of the present disclosure. The bar environment 100 includes a user 102, a cocktail mix apparatus 104, a cocktail serving 106, a cocktail serving 108, a user 110 and a user 112. The user 102 includes but may not be limited to a bartender, and a barkeeper. The user 102 prepares the cocktail servings 106-108 using a cocktail mixture provided in the cocktail mix apparatus 104. The user 110 and the user 112 include but may not be limited to the customers, the clients and the guests. The cocktail mix apparatus 104 is configured to prepare two cocktail serves (the cocktail serving 106 and the cocktail serving 108). In addition, the cocktail mix apparatus 104 is configured for single use only.

It may be noted that in FIG. 1, three users, the user 102, the user 110 and the user 112, are shown; however, those skilled in the art would appreciate that in any bar environment, more than three users may be present. For e.g., the bar environment 100 may include one or more bartenders, one or more customers and the like. In addition, the bar environment 100 may include plurality of the cocktail mix apparatus 104 for serving the one or more customers. The bar environment 100 may be set at clubs, bars, restaurants and the like.

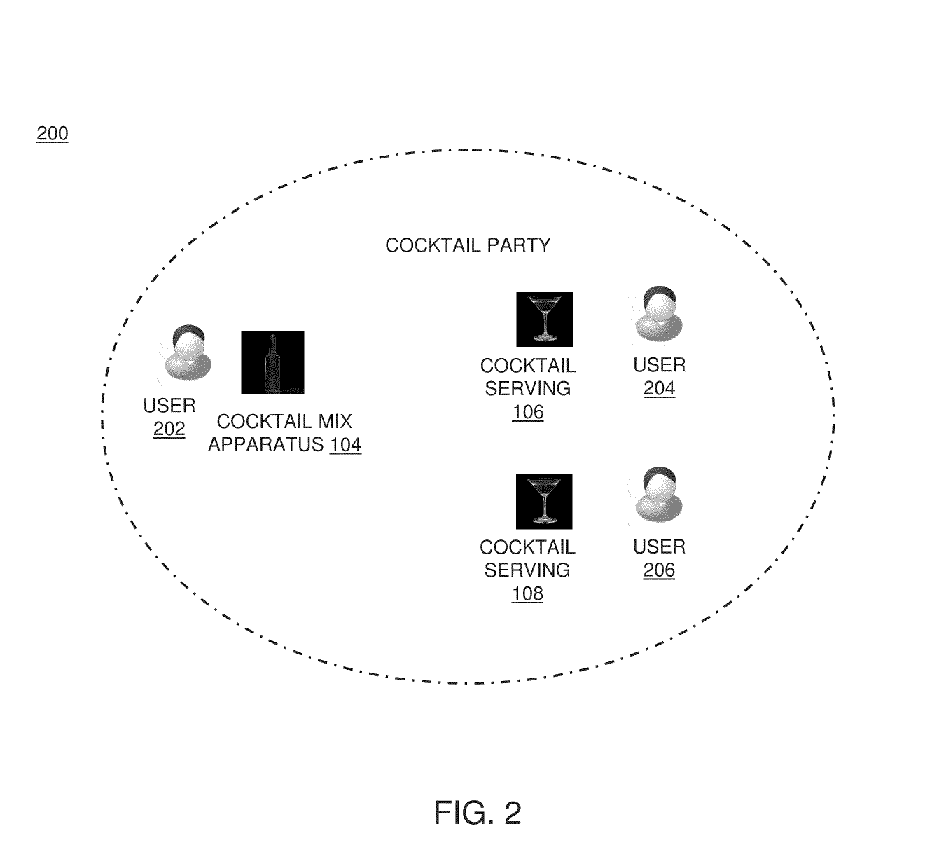

FIG. 2 illustrates an exemplary environment 200 for a cocktail party, in accordance with an embodiment of the present disclosure. The cocktail party environment 200 includes a user 202, the cocktail mix apparatus 104, the cocktail serving 106, the cocktail serving 108, the user 204 and the user 206. The user 202 includes but may not be limited to a host, a waiter and a bartender. As described in the description of FIG. 1, the user 202 prepares the cocktail serves (the cocktail serving 106 and the cocktail serving 108) for the user 204 and the user 206. The user 204 and the user 206 include but may not be limited to the guests and the hosts. As described above, the cocktail mix apparatus 104 is configured to prepare two cocktail serves (the cocktail serving 106 and the cocktail serving 108). In addition, the cocktail mix apparatus 104 is configured for single use only.

It may be noted that in FIG. 2, three users, the user 202, the user 204 and the user 206 are shown; however, those skilled in the art would appreciate that in any cocktail party environment, more than three users may be present. For e.g., the cocktail party environment 200 may include the one or more bartenders, one or more hosts, the one or more guests and the like. In addition, the cocktail party environment 200 may include plurality of the cocktail mix apparatus 104 for serving the one or more guests and the one or more hosts. The cocktail party environment 200 may be set for various occasions including receptions, business occasions, celebrations and the like.

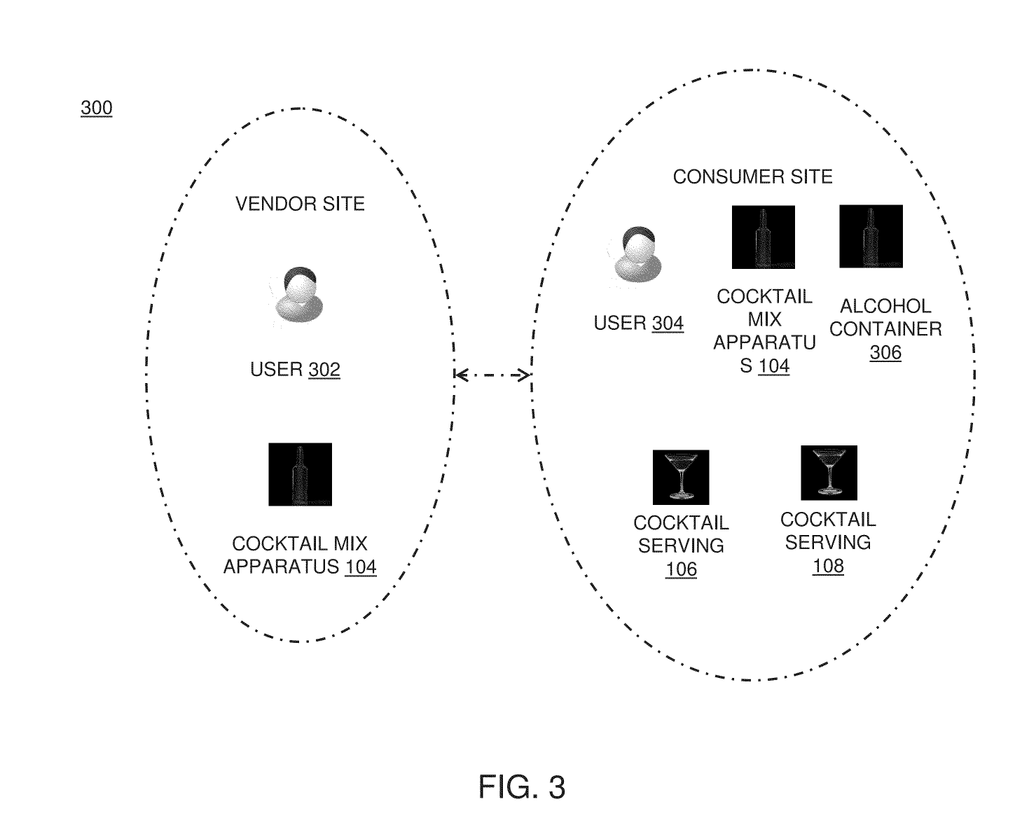

FIG. 3 illustrates an exemplary environment 300 showing interaction between a vendor and a consumer, in accordance with an embodiment of the present disclosure. The environment 300 includes a vendor site and a consumer site. The vendor site includes a user 302 and the cocktail mix apparatus 104. The consumer site includes a user 304, the cocktail mix apparatus 104, an alcohol container 306, the cocktail serving 106 and the cocktail serving 108. The user 302 includes a manufacturer, a vendor and the like. The user 304 includes the consumers, the bartenders and the like. At the vendor site, the user 302 provides a pre-mix for preparing cocktails in the cocktail mix apparatus 104. Further, at the consumer site, the user 304 purchases or obtains the cocktail mix apparatus 104 to prepare the cocktail serves (the cocktail serving 106 and the cocktail serving 108) utilizing an alcohol from the alcohol container 306. The user 304 may prepare the cocktail serves for self, other individuals or both.

It may be noted that in FIG. 3, the vendor site includes one user (the user 302); however, those skilled in the art would appreciate that one or more users may be present at the vendor site. Moreover, the one or more users may include manufacturers, employees of a company preparing the pre-mix, vendors and the like. Further, the consumer site may include the bar environment 100, the cocktail party environment 200, restaurants, clubs and the like. Further, the user 304 includes one or more users. The one or more users may include individuals preparing cocktails for self and for other individuals.

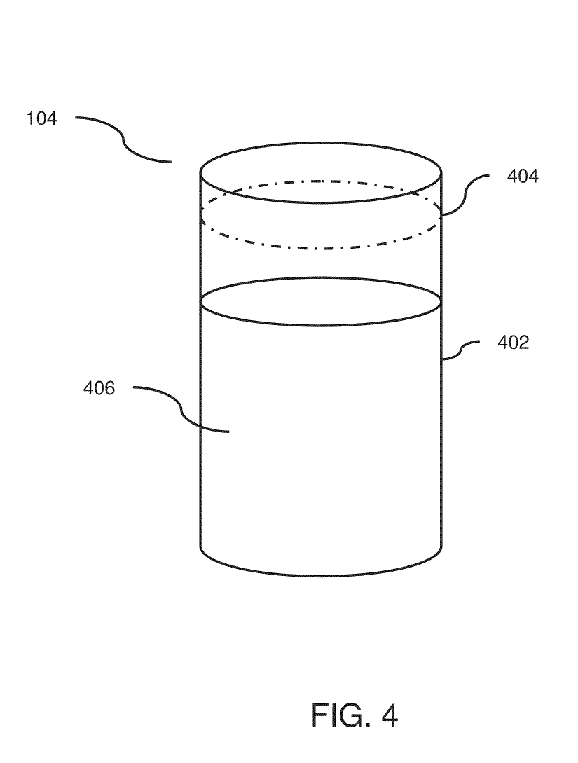

FIG. 4 illustrates the cocktail mix apparatus 104 holding a cocktail mixture, in accordance with an embodiment of the present disclosure. The cocktail mix apparatus 104 includes a container 402 with a lid 404. The lid 404 is provided to cover the container 402. The container 402 of the cocktail mix apparatus 104 holds the cocktail mixture 406. The cocktail mixture 406 includes a plurality of ingredients in a pre-determined amount. The plurality of ingredients may include one or more diluters including spirits, soda water, fruit juices and the like.

It may be noted that the cocktail mixture 406 provided by the manufacturers in the container 402 is meant to prepare the two cocktail serves (the cocktail serving 106 and the cocktail serving 108). Moreover, the cocktail mixture 406 is provided for one time use. Therefore, once the container 402 is opened by the consumer, the cocktail mixture 406 must be wholly utilized. Further, the cocktail mixture 406 is prepared and stored in the container 402 without using preservatives. Furthermore, the cocktail mixture 406 is packaged in the container 402 under sterile environment to prevent spoilage of the cocktail mixture 406. Furthermore, the cocktail mixture 406 provided in the container 402 can be stored without need of refrigeration.

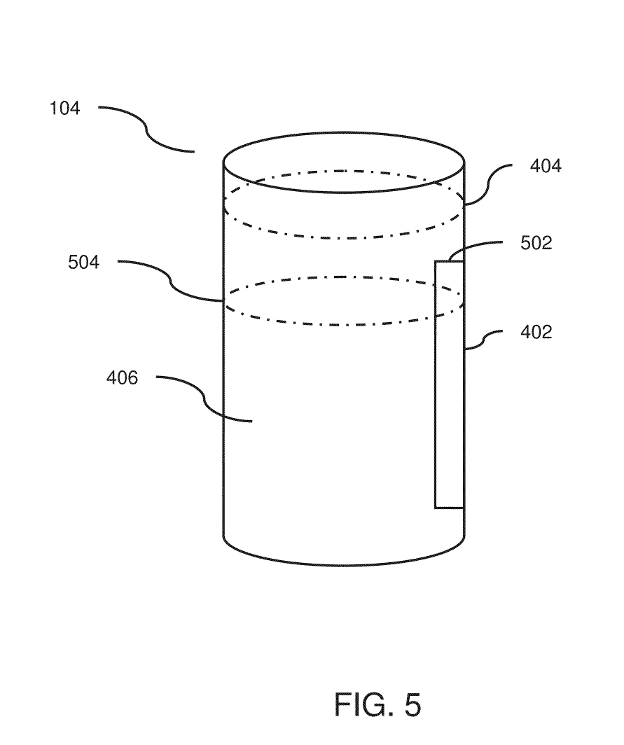

FIG. 5 illustrates the cocktail mix apparatus 104 with a label embossed, in accordance with an embodiment of the present disclosure. As described above, in the description of FIG. 4, the cocktail mix apparatus 104 includes the container 402 and the lid 404. In addition, the cocktail mix apparatus 104 includes a label 502 and a measuring device 504. The container 402 stores the cocktail mixture 406. The label 502 is printed or embossed on the container 402 to display the plurality of ingredients present in the cocktail mixture 406. Further, the measuring device 504 is embossed on at least one of the label 502 and the container 402.

It may be noted that FIG. 5 shows the measuring device 504 as a marker line to indicate amount of alcohol to be mixed with the cocktail mixture 406 to prepare the cocktail serves (the cocktail serving 106 and the cocktail serving 108); however, those skilled in the art would appreciate that the measuring device 504 may be a scale embossed on at least one of the label 502 and the container 402. In addition, various levels of indications may be provided by the measuring device 504 to prepare the cocktail serves (the cocktail serving 106 and the cocktail serving 108) with varying amounts of the alcohol.

In accordance with an embodiment of the present disclosure, an exemplary scenario illustrating use of the cocktail mix apparatus 104 is provided. Initially, the cocktail mix apparatus 104 is provided by the manufacturer or the vendor to the consumer. The consumer opens the container 402 of the cocktail mix apparatus 104 and empties the contents (the cocktail mixture 406) into a cocktail shaker. Following this, the consumer uses the container 402 to measure an exact amount of the alcohol as indicated by the measuring device 504 on the cocktail mix apparatus 104. Following this, the consumer pours the alcohol into the cocktail shaker. Finally, the consumer shakes the cocktail drink formed by mixing the alcohol and the cocktail mixture 406 with ice and serves the cocktail drink to the other person or to himself.

In an embodiment of the present disclosure, the container 402 serves as a measuring device for the alcohol to prepare a perfect cocktail for two servings. In addition, the cocktail mixture 406 provided herein is a fresh mix. Further, the container 402 provided herein enables longer shelf life for the cocktail mixture 406. Furthermore, refrigeration of the cocktail mixture 406 is not required. Furthermore, the measuring device 504 is provided built-in on each of the container 402 to create the perfect cocktail without need of additional measuring devices (for e.g., shot glasses, mixers and the like). Furthermore, the container 402 acts as measuring equipment. Furthermore, the label 502 embossed on the container 402 describes the contents of the cocktail mixture 406. Furthermore, the container 402 holds the label 502 describing marks indicating the amount of alcohol to be added to the cocktail mixture 406. Furthermore, the label 502 may provide instructions for using the cocktail mixture 406 to prepare the cocktail drink.

In an embodiment of the present disclosure, the container 402 of an appropriate size for the cocktail mixture 406 for the cocktail for two persons is provided.

In another embodiment of the present disclosure, the container 402 is a single use container with a built-in measuring device for minimizing use of the chemical preservatives, freezing point depressants and like components that may pose a serious health hazard. The foregoing descriptions, of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

What is claimed is:

1. A liquid dispensing apparatus comprising:
a container configured to store a cocktail mixture, wherein said cocktail mixture comprises a plurality of ingredients in a pre-determined amount, and wherein said plurality of ingredients being one or more diluters;
a label being embossed on said container, wherein said label displays said plurality of ingredients present in said cocktail mixture; and
a measuring device, wherein said measuring device being embossed on at least one of said label and said container.

2. The liquid dispensing apparatus as recited in claim 1, wherein said cocktail mixture being configured for one time use.

3. The liquid dispensing apparatus as recited in claim 1, wherein said container being a single use container with a built-in measuring device being configured to minimize use of chemical preservatives, freezing point depressants and components that may pose a serious health hazard.

4. The liquid dispensing apparatus as recited in claim 1, wherein said cocktail mixture being configured to prepare two servings.

5. The liquid dispensing apparatus as recited in claim 1, wherein said cocktail mixture being storable in a non-refrigerating mode prior to use.

6. The liquid dispensing apparatus as recited in claim 1, wherein said cocktail mixture being packaged in said container under sterile environment.

7. The liquid dispensing apparatus as recited in claim 1, wherein said measuring device being indication of amount of alcohol to be mixed with said cocktail mixture.

8. A liquid dispensing apparatus comprising:
a container configured to store a cocktail mixture, wherein said cocktail mixture comprises a plurality of ingredients in a pre-determined amount, and wherein said plurality of ingredients being one or more diluters, wherein said cocktail mixture being storable in a non-refrigerating mode and being packaged in said container under sterile environment;
a label being embossed on said container, wherein said label displays said plurality of ingredients present in said cocktail mixture; and
a measuring device, wherein said measuring device being embossed on at least one of said label and said container.

9. The liquid dispensing apparatus as recited in claim 8, wherein said cocktail mixture being configured for one time use.

10. The liquid dispensing apparatus as recited in claim 8, wherein said cocktail mixture being configured to prepare two servings.

11. The liquid dispensing apparatus as recited in claim 8, wherein said measuring device being indication of amount of alcohol to be mixed with said cocktail mixture.

12. A liquid dispensing apparatus comprising:
a container configured to store a cocktail mixture, wherein said cocktail mixture comprises a plurality of ingredients in a pre-determined amount, and wherein said plurality of ingredients being one or more diluters, wherein said cocktail mixture being storable in a non-refrigerating mode and being packaged in said container under sterile environment;
a label being embossed on said container, wherein said label displays said plurality of ingredients present in said cocktail mixture; and
a measuring device, wherein said measuring device being embossed on at least one of said label and said container, said measuring device indicates the amount of alcohol to be mixed with said cocktail mixture.

13. The liquid dispensing apparatus as recited in claim 14, wherein said cocktail mixture being configured for one time use.

14. The liquid dispensing apparatus as recited in claim 14, wherein said cocktail mixture being configured to prepare two servings.
